(19) United States
(12) Patent Application Publication
(10) Pub. No.: US 2007/0274906 A1
(43) Pub. Date: Nov. 29, 2007

(54) Method for manufacturing aromatic metal containing zeolite

(76) Inventor: Dai-Su Lee, Gyeonggi-do (KR)

Correspondence Address: VENABLE LLP, P.O. BOX 34385, WASHINGTON, DC, 20043-9998, US

(21) Appl. No.: 11/802,768

(22) Filed: May 24, 2007

(30) Foreign Application Priority Data
May 24, 2006 (KR) 10-2006-0046719

(51) Int. Cl. C01B 39/00

(52) U.S. Cl. 423/700

(57) ABSTRACT

A method for fabricating a zeolite-containing aromatic metal compound according to the present invention is characterized in that fine metal powder of 98 wt %, zeolite powder of 1 wt % and stearic acid of 1 wt % are mixed with respect to the total weight of the compound, the mixed compound is sintered, and an aroma is absorbed into the compound in a vacuum. Also, the present invention provides a cost-effective way of fabricating a zeolite-containing aromatic metal compound because an additional aromatic absorbers is not needed by mixing and sintering the zeolite having very large number of nanopores and metal powder and is then applicable to the accessories in various types.

### FIELD OF THE INVENTION

The present invention relates to a method for fabricating an aromatic metal compound including zeolite; and, more particularly, to a method for fabricating an aromatic metal compound having no additional aromatic absorber by mixing and sintering zeolite having very large number of nanopores and metal powder, wherein the aromatic metal compound according to the present invention can reduce the fabricating cost and can be applicable to accessories in various types.

### DESCRIPTION OF RELATED ART

As shown in FIG. 1, a conventional method for fabricating an aromatic metal compound is introduced in such a manner that an adsorbing plate for maintaining an aroma is attached between two metal plates and an aroma is absorbed into the adsorption plate in a vacuum or metal powder are mixed with a metal oxide composition in order to form the porous material, the mixture is sintered, and an aroma is absorbed into the mixture in a vacuum.

However, as shown in FIG. 1, although the method in which the adsorbing plate is formed between two metal plates is available to the fabrication of board accessories, this method has a problem in that it is difficult to fabricate the accessories in various types.

Moreover, since the method in which the aromatic metal compound is formed by mixing the metal powder with the metal oxide compositions needs an additional process for forming the porous material, this method has a problem in that the processing time and cost is increased.

### SUMMARY OF THE INVENTION

It is, therefore, an object of the present invention to provide a method for fabricating a zeolite-containing aromatic metal compound in which an aromatic metal compound having no additional aromatic absorbers is formed by mixing and sintering zeolite having very large number of nanopores and metal powder, wherein the aromatic metal compound according to the present invention can reduce the fabricating cost and can be applicable to the accessories in various types.

In accordance with an aspect of the present invention, there is provided a method for fabricating the zeolite-containing aromatic metal compound according to the present invention is characterized in that fine metal powder of 98 wt %, zeolite powder of 1 wt % and stearic acid of 1 wt % are mixed with respect to the total weight of the compound, the mixed compound is sintered, and an aroma is absorbed into the compound in a vacuum.

Moreover, it is preferable that the sizes of the particles in the metal powder, the zeolite powder and the stearic acid are 1200 mesh or less.

Additionally, a silver powder can be effectively used as the metal powder.

Moreover, it is preferable that the metal powder is a gold, copper or zinc-copper alloy powder or a tin-copper alloy powder.

### BRIEF DESCRIPTION OF THE DRAWINGS

FIG. 1 is a schematic view illustrating a method for fabricating a conventional aromatic metal compound.

FIG. 2 is a schematic view illustrating a method for fabricating an aromatic metal compound according to the present invention.

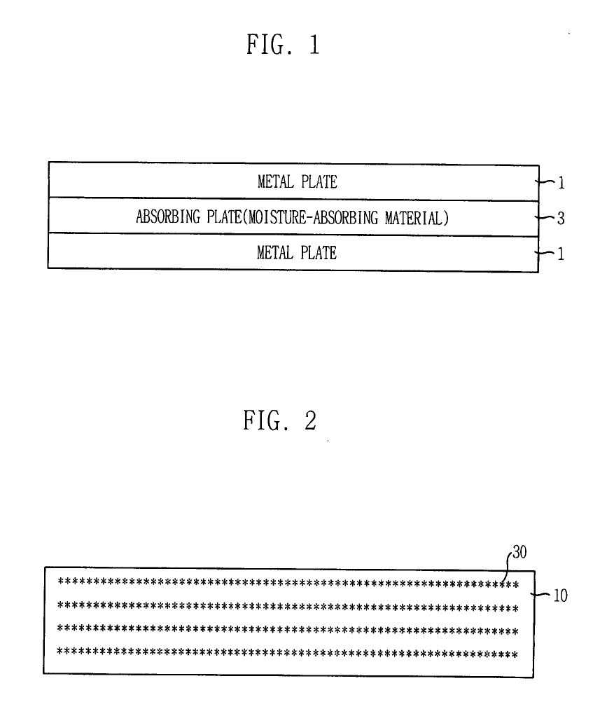

### DETAILED DESCRIPTION OF THE INVENTION

The method for fabricating the zeolite-containing aromatic metal compound according to the present invention is characterized in that fine metal powder of 98 wt %, zeolite powder of 1 wt % and stearic acid of 1 wt % are mixed with respect to the total weight of the compound, the mixed compound is sintered, and an aroma is absorbed into the compound in a vacuum.

Moreover, it is preferable that the sizes of the particles in the metal powder, the zeolite powder and the stearic acid are 1200 mesh or less.

Additionally, a silver powder can be effectively used as the metal powder.

Moreover, it is preferable that the metal powder is a gold, copper or zinc-copper alloy powder or a tin-copper alloy powder.

Hereinafter, the method for fabricating an aromatic metal compound including zeolite according to the preferred embodiment of the present invention will be described in detail referring to the accompanying drawing.

FIG. 2 is a schematic view illustrating the method for fabricating the aromatic metal compound including zeolite according to the preferred embodiment of the present invention.

The method for fabricating the aromatic metal compound including zeolite according to the preferred embodiment of the present invention is characterized in that fine metal powder of 98 wt % as a basic material, zeolite powder of 1 wt % and stearic acid of 1 wt % are mixed with respect to the total weight of the compound, the mixed compound is sintered, and an aroma is absorbed into the compound in a vacuum.

Zeolite is called “stone that boils” and there are many kinds of zeolites; however, these zeolites have the same characteristics in an amount of contained water or moisture, features of the crystallization and shape of the products.

Moreover, the hardness of zeolites is not over 6 and the specific gravity thereof is about 2.2. Generally, the zeolites are colorless transparent or white transparent. Most kinds of zeolites are melted in a hydrochloric acid and then they exist in the shape of a glue but a few kinds of them are not melted in the hydrochloric acid.

There are analcime, apophyllite, chabazite, a natrolite, heulandite, stilbite, laumontite and inesite, etc., as the important things of the zeolites. Moreover, the zeolites exist in cavities and interstices of the basic igneous rocks such as granite and gneiss or exist in granite or gneiss as the secondary minerals.

Additionally, the zeolite can be obtained sometimes from a metalliferous vein or a gold vein. Since the bind of each atom is loose in a crystal structure and this crystal structure is maintained even if the moisture filling up the spaces of the atoms gets out of the structure at a high temperature, the zeolite can absorbs other microparticles so that it is frequently used as an absorber.

Being different from the conventional aromatic metal compound, it is not necessary to have an absorber to absorb an aroma by mixing the zeolite 30 having a porous structure of the nano size with the metal powder 10.

The stearic acid, as a fatty acid, has 17 carbon atoms and is used as an emulsifying agent to make different substances mixed.

On the other hand, the metal powder 10 can obtain the bactericidal action by using the Ag powder and the accessories of the earrings, bracelet, ring, a necklace, etc., can be luxuriously manufactured by using the gold, copper or zinc-copper alloy powder or a tin-copper alloy powder.

Moreover, it is preferable that the size of the particles in the metal powder 10, the zeolite powder 30 and the stearic acid is 1200 mesh or less.

According to the result of an experiment conducted based on the present invention, the zeolite-containing aromatic metal compound fabricated by the present invention make the absorption of the aroma increased by more than 50%, compared to the mixture of the conventional aluminum oxide and metal powder, and then the time to exhale the aroma is elongated over two times.

As apparent from the above, the present invention provides a cost-effective way of fabricating zeolite-containing aromatic metal compounds because an additional aromatic absorbers is not needed by mixing and sintering the zeolite having very large number of nanopores and metal powder and is then applicable to the accessories in various types.

While the present invention has been described with respect to the particular embodiments, it will be apparent to those skilled in the art that various changes and modifications may be made without departing from the spirit and scope of the invention as defined in the following claims.

What is claimed is:

1. A method for fabricating a zeolite-containing aromatic metal compound, the method comprising the steps of:
mixing a fine metal powder of 98 wt %, a zeolite powder of 1 wt % and a stearic acid of 1 wt %;
sintering the mixed compound; and
absorbing an aroma into the compound in a vacuum.

2. The method in accordance with the claim 1, wherein sizes of particles in the metal powder, the zeolite powder and the stearic acid are 1200 mesh or less.

3. The method in accordance with the claim 1 or 2, wherein the metal powder is a silver powder.

4. The method in accordance with the claim 1 or 2, wherein the metal powder is a gold, copper or zinc-copper alloy powder or a tin-copper alloy powder.
